(19) United States
(12) Patent Application Publication
(10) Pub. No.: US 2013/0255716 A1
(43) Pub. Date: Oct. 3, 2013

(54) Microwave Oven Cleaner

(71) Applicants: Kenneth George Underwood, Wellingborough (GB); Miriana Dimma McGuire, Rushden (GB)

(72) Inventors: Kenneth George Underwood, Wellingborough (GB); Miriana Dimma McGuire, Rushden (GB)

(73) Assignee: MYKAL INDUSTRIES LIMITED, Wellingborough, Northants (GB)

(21) Appl. No.: 13/641,722

(22) PCT Filed: Jul. 19, 2012
(86) PCT No.: PCT/GB12/51728

§ 371 Date: Jun. 11, 2013

(30) Foreign Application Priority Data
Jul. 21, 2011 (GB) 1112605.9

(51) Int. Cl. C11D 1/94; C11D 17/00

(52) U.S. Cl. CPC C11D 1/94; C11D 17/00
USPC 134/1; 222/190; 510/234

(57) ABSTRACT

The invention provides a method and a system for cleaning a microwave oven, and a suitable foaming microwave cleaning composition.

The invention provides a foaming microwave cleaning composition and a method and a system for cleaning the interior of a microwave oven, using the foaming microwave cleaning composition.

### BACKGROUND OF THE INVENTION

Over time, the inside of microwave ovens can become coated with food residue on repeated use, particularly in commercial settings. This residue is often difficult or awkward to remove using conventional cleaning products. The residue adhering to the inside of the microwave oven is often dehydrated and in order to remove it, abrasive and aggressive cleaning products may be needed. The interior of a microwave can become damaged by the use of abrasive cleaners. Further, the use of highly caustic cleaning products may damage the interior of the machine and may also give rise to toxic by-products if they are not sufficiently rinsed away after cleaning. Conventional oven cleaners will often have a pH of about 13 or 14, typically 14, which may be a source of skin irritation in a user and is also undesirable for use in a food preparation setting.

The use of microwave ovens in domestic and commercial situations is increasing, particularly as a timesaving device. There is a particular need for a suitable cleaning product that will clean the microwave oven quickly and efficiently.

Microwave cleaning compositions are known, for example from US 2006/0289442 that provides a device comprising a sponge product holding an absorbed cleaning solution. In use, this device is placed into a microwave oven that is turned on for at least five minutes. As a result, the sponge product becomes very hot, and has to be left for an additional period to cool before it can safely be handled.

Liquid cleaners may be used in a microwave oven, but these require the use of manual effort on the part of the user, and can result in damage from scouring pads etc.

U.S. Pat. No. 5,290,985 suggests the use of a removable insert that may be fitted to the interior of the microwave in order to prevent splatter attaching to the walls and floor. However, these products can be awkward to fit, and in general, physical cleaning of the oven would still be needed.

The present invention seeks to provide a composition, a system and a method for cleaning a microwave oven quickly and easily, with minimal effort on the part of the user. Further, the invention uses the power of the microwave to clean itself. The materials used are generally non-toxic in a kitchen environment.

The composition of the present invention is for use in cleaning a microwave oven, suitably in a domestic or commercial environment. The invention embraces a system for cleaning a microwave oven comprising the described composition of the invention, packaged in a foam- or mousse-forming pump dispenser.

### DESCRIPTION

The present invention relates to a foaming microwave cleaning composition comprising at least one solvent having a boiling point of from 70 to 180° C., at least one high foaming amphoteric surfactant, at least one high foaming water-soluble nonionic surfactant, an optional cationic biocide, and an aqueous carrier, the composition having a pH of from 7.0 to 12.5.

The invention further provides a system for use in cleaning a microwave oven, which comprises the foaming microwave cleaning composition of the invention, filled in a foam- or mousse-forming pump dispenser.

The invention further provides a method of cleaning a microwave oven, wherein the method comprises applying the foaming composition described above to the interior of the microwave oven, applying from 100 to 3200 watts, preferably from 600 to 1200 watts of microwave energy for a time sufficient to allow the foam to form a vapour, suitably a time of from 14 seconds to 7 minutes 30 seconds, preferably from 30 to 75 seconds, then removing residue from the interior of the microwave oven. A method is also provided for cleaning a microwave oven using the system of the invention.

The at least one solvent used in the present invention is an organic solvent having a boiling point of from 70 to 180° C., preferably from 100 to 130° C. The solvent is preferably water-miscible. Suitable solvents are low-odour and non-tainting. Suitable solvents include glycol ethers, such as those having the formula

Rₐ—O—R_{b}—OH

wherein Rₐ is an alkyl of 1 to 20 carbon atoms, or an aryl of at least 6 carbon atoms and R_{b} is an alkylene of 1 to 8 carbons or is an ether or polyether containing from 2 to 20 carbon atoms.

Examples of suitable glycol ether solvents include ethylene glycol monobutyl ether (butyl cellosolve), diethylene glycol monobutyl ether (butyl carbitol), triethylene glycol monobutyl ether, mono-, di-, tri-propylene glycol monobutyl ether, tetraethylene glycol monobutyl ether, mono-, di-, tri-propylene glycol monomethyl ether, propylene glycol monomethyl, ether, ethylene glycol monohexyl ether, diethylene glycol monohexyl ether, propylene glycol tertiary butyl ether, ethylene glycol monoethyl ether, ethylene glycol monomethyl ether, ethylene glycol monopropyl ether, ethylene glycol monopentyl ether, diethylene glycol monomethyl ether, diethylene glycol monoethyl ether, diethylene glycol monopropyl ether, diethylene glycol monopentyl ether, triethylene glycol monomethyl ether, triethylene glycol monoethyl ether, triethylene glycol monopropyl ether, triethylene glycol monopentyl ether, triethylene glycol monohexyl ether, mono-, di-, tri-propylene glycol monoethyl ether, mono-, di-,tri-propylene glycol monopropyl ether, mono-, di-, tri-propylene glycol monopentyl ether, mono-, di-, tri-propylene glycol monohexyl ether, mono-, di-, tri-butylene glycol mono methyl ether, mono-, di-, tri-butylene glycol monoethyl ether, mono-, di-, tri-butylene glycol monopropyl ether, mono-, di-, tri-butylene glycol monobutyl ether, mono-, di-, tri-butylene glycol monopentyl ether, mono-, di-, tri-butylene glycol monohexyl ether, ethylene glycol monoacetate and dipropylene glycol propionate and mixtures thereof. Preferred examples include 1-methoxy-2-propanol (e.g. Dowanol PM) and 3-butoxypropan-2-ol (e.g. Dowanol PnB).

Other suitable solvents include water-miscible alcohols, especially C1-4 alcohols, optionally substituted with a C1-4 alkoxy group, such as ethanol, propanol, butanol, isopropanol, and mixtures thereof.

Other suitable solvents include glycols, (such as ethylene glycol, propylene glycol and hexylene glycol), water-miscible ethers (such as diethylene glycol diethylether, and propylene glycol dimethylether), lower esters of monoalkyl ethers of ethylene glycol or propylene glycol (such as propylene glycol monomethyl ether acetate) and mixtures thereof.

Preferred solvents include 1-methoxy-2-propanol, ethanol, isopropanol and 3-butoxypropan-2-ol and mixtures thereof.

Suitably, the solvent is present in the microwave cleaning composition of the present invention in an amount of from 0.1 to 12 wt %, preferably from 1 to 10 wt % and more preferably 2 to 8 wt %.

The microwave cleaning composition of the invention comprises at least one high foaming amphoteric surfactant. The amphoteric surfactant has good foam stability, generally good soil penetration and is easily rinsed.

Suitable amphoteric surfactants include water-soluble betaine and propionate surfactants or mixtures thereof. Betaine surfactants are suitably chosen from those of the general formula

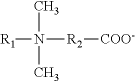

wherein R₁ is an alkyl group containing from 8 to 18 carbon atoms, or the amido radical which may be represented by the following general formula:

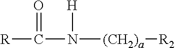

wherein R is an alkyl group having from 8 to 18 carbon atoms, a is an integer having a value of from 1 to 4 inclusive, and R₂ is a C₁-C₄ alkylene group. Examples of such water-soluble betaine surfactants include dodecyl dimethyl betaine, as well as cocoamidopropylbetaine, (e.g. Lakeland CAB and Surfac B4), cocoalkyl dimethyl betaine (e.g. Lakeland CTA/N) and bis-(1,2-ethanediol) tallow dimethyl betaine (e.g. Lakeland TAB II).

Suitable propionate surfactants include dipropionates or monopropionates of the formula

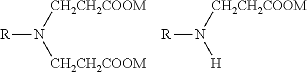

wherein R is a C₈₋₂₂ alkyl group, and M is hydrogen or an alkali metal ion, for example sodium or potassium.

Examples of such water-soluble propionate surfactants include dipropionates such as β-alanine, N-(2-carboxy ethyl) N-coco alkyl derivatives (e.g. Lakeland AMA, AMA 38 or AMA 100), N-(2-carboxyethyl) N-tallow alkyl derivative (30% solution) (e.g. Lakeland ODA), cocamidopropionate sodium salts (e.g. Librateric AA-30 and AA-38) and monopropionates such as N-cocoalkylaminopropionic acid (e.g. Lakeland ACP 70) or mixtures thereof.

Further suitable amphoteric surfactants include alkylamine dicarboxylates such as Surfac BH30.

Preferred amphoteric surfactants include β-alanine, N-(2-carboxy ethyl) N-coco alkyl derivatives and sodium salts thereof, cocamidopropylbetaine, alkylamine dicarboxylates and mixtures thereof.

The at least one amphoteric surfactant may be present in an amount of from 0.1 to 5.0 wt %, preferably from 0.3 to 4.0 wt %, more preferably 1.0 to 3.5 wt %.

The at least one nonionic surfactant useful in the present invention generally has good water solubility, high foaming properties, good grease solubilising properties and is easily rinsed. Generally the non-ionic surfactants suitable for use in the present invention will have an HLB value of from 10 to 15, preferably from 11 to 14. Such nonionic solvents will generally have high foam forming ability.

Suitable nonionic surfactants include polyethylene oxide condensates of alkyl phenols, such as the condensation products of C₆₋₁₂ alkyl phenols with 5 to 25 moles of ethylene oxide per mole of alkyl phenol. Examples include nonyl phenol condensed with about 9.5 moles of ethylene oxide per mole of nonyl phenol; dodecylphenol condensed with about 12 moles of ethylene oxide per mole of phenol; dinonyl phenol condensed with about 15 moles of ethylene oxide per mole of phenol and diisooctyl phenol condensed with about 15 moles of ethylene oxide per mole of phenol.

Further useful nonionic surfactants include condensation products of C₈⁻₂₂ aliphatic alcohols with from about 1 to about 60 moles of ethylene oxide. Examples include the condensation product of myristyl alcohol with about 10 moles of ethylene oxide per mole of alcohol, the condensation product of coconut alcohol (C10-14) with about 9 moles of ethylene oxide, the condensation product of C₆-C₁₁ straight-chain alcohols with from about 3 to about 6 moles of ethylene oxide, e.g. Alfonic® 810-4.5 (HLB of about 12), Alfonic® 810-2 (HLB of about 12); and Alfonic® 610-3.5 (HLB of 10), or polyoxyethylene (6) C9-11 alcohol, eg Surfac UN 65/95, Neodol 91-6 and Caflon NE600.

Further examples of useful nonionic surfactants include the Neodol C₉⁻₁₁ ethoxylated alcohols available from Shell Chemical Company, e.g. Neodol 91-2.5 (having about 2.5 ethoxy groups per molecule), Neodol 91-6 (having about 6 ethoxy groups per molecule) and Neodol 91-8 (having about 8 ethoxy groups per molecule). Still further examples of ethoxylated alcohols include the Rhodasurf® DA series of branched isodecyl alcohol ethoxylates available from Rhodia, e.g. Rhodasurf DA-530 (4 moles of ethoxylation and an HLB of 10.5), Rhodasurf DA-630 (6 moles of ethoxylation with an HLB of 12.5) and Rhodasurf DA-639 (a 90% solution of DA-630); and C₁₂₋₁₅ ethoxylated alcohols such as Neodol 25-12.

Other examples of useful nonionic surfactants include those having a formula RO(CH₂CH₂O)ₙH wherein R is a mixture of linear, even carbon-number hydrocarbon chains ranging from C₁₂H₂₅ to C₁₆H₃₃ and n represents the number of repeating units and is a number of from about 1 to about 12, for example, the Genapol 26-L series.

A further class of suitable nonionic surfactants include those based on alkoxy block copolymers, and in particular, compounds based on ethoxy/propoxy block copolymers. Polymeric alkylene oxide block copolymers include nonionic surfactants in which the major portion of the molecule is made up of block polymeric C₂-C₄ alkylene oxides. Such nonionic surfactants, while preferably built up from an alkylene oxide chain starting group, can have as a starting nucleus almost any active hydrogen containing group including, without limitation amides, phenols, thiols and secondary alcohols. Examples include those of the formula:

HO-(EO)ₓ(PO)_{y}(EO)_{z}—H

where EO represents ethylene oxide,

PO represents propylene oxide,

y equals at least 15,

(EO)_{x+y} equals 20 to 50% of the total weight of said compounds, and, the total molecular weight is preferably in the range of about 2000 to 15,000, for example those available under the PLURONIC tradename from BASF or Emulgen from Kao.

Further suitable nonionic surfactants include those of the formula:

R-(EO,PO)ₐ(EO,PO)_{b}—H

wherein R is an alkyl, aryl or aralkyl group, where the R group contains 1 to 20 carbon atoms, the weight percent of EO is within the range of 0 to 45% in one of the blocks a, b and within the range of 60 to 10% in the other of the blocks a, b and the total number of moles of combined EO and PO is in the range of 6 to 125 moles, with 1 to 50 moles, with 1 to 50 moles in the PO rich block and 5 to 100 moles in the EO rich block.

These surfactants include butoxy derivatives of propylene oxide/ethylene oxide block polymers having molecular weights within the range of about 2000 to 5000.

Still further useful nonionic surfactants containing polymeric butoxy (BO) groups include those of the formula:

RO—(BO)ₙ(EO)ₓ—H

wherein R is an alkyl group containing 1 to 20 carbon atoms,

n is about 5-15 and x is about 5-15.

Also useful are nonionic block copolymer surfactants, which also include polymeric butoxy groups, such as those of the formula:

HO-(EO)_{X}(BO)ₓ(EO)_{Y}—H

wherein n is about 5-15, preferably about 15,

x is about 5-15, preferably about 15, and

y is about 5-15, preferably about 15.

Still further useful nonionic block copolymer surfactants include ethoxylated derivatives of propoxylated ethylene diamine, which may be represented by such those of the formula:

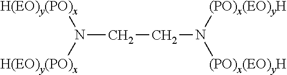

where (EO) represents ethoxy,

(PO) represents prepoxy, and

the amount of (PO)ₓ is such as to provide a molecular weight prior to ethoxylation of about 300 to 7500, and the amount of (EO)_{y} is such as to provide about 20% to 90% of the total weight of said compound.

Further suitable nonionic surfactants include amine oxides such as C₁₀₋₂₀ alkyl di(C₁-C₇) amine oxides, e.g. lauryl dimethyl amine oxide, myristyl dimethyl amine oxide, dimethyl cocoamine oxide, dimethyl (hydrogenated tallow) amine oxide, and myristyl/palmityl dimethyl amine oxide; C₁₀₋₂₀ alkyl di(hydroxy C₁-C₇) amine oxides e.g. bis(2-hydroxyethyl) cocoamine oxide, bis(2-hydroxyethyl) tallowamide oxide, and bis(2-hydroxyethyl) stearylamineoxide;

C₁₀₋₂₀ alkylamidopropyl di(C₁-C₇) amine oxides e.g. cocoamidoproyl dimethyl amine oxide and tallowamidopropyl dimethyl amine oxide; and

C₁₀₋₂₀ alkymorpholine oxides.

Preferably the amine oxide constituent is an alkyl di(lower alkyl) amine oxide of the following structure:

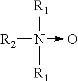

wherein each:

R₁ is a straight chained C₁-C₄ alkyl group, preferably both R₁ are methyl groups; and

R₂ is a straight chained C₈-C₁₈ alkyl group, preferably is C₁₀-C₁₄ alkyl group, most preferably is a C₁₂ alkyl group.

The amine oxide constituent is preferably lauryl dimethyl amine oxide.

Particularly useful amine oxides include for example amine oxides available in the AO series from Tomah Products Inc.; in the AMMONYX series from Stepan Co.; in the BARLOX series from Lonza Inc. (Fairlawn, N.J.), in the RHODAMOX series from Rhone-Poulenc Inc. (Cranbury N.J.), as well as in the MACKAMINE series of products from McIntyre Group Ltd, e.g. Mackamine CAO.

Further suitable nonionic surfactants include polyglucosides, including alkylmonoglucosides and alkylpolyglucosides. The alkylpolyglucosides are generally condensation products of long chain alcohols (e.g. C₈₋₃₀) with sugars, starches or polymers thereof. These compounds may have the formula (S)ₙ—O—R, where S is a sugar moiety such as glucose, fructose, mannose or galactose, n is an integer of from about 1 to about 1000, and R is a C₈₋₃₀ alkyl group. Suitable examples include Glucopon 625 CS and Glucopon 600CS.

Particularly preferred non-ionic surfactants for use in the present invention include polyoxyethylene (6), C9-11 alcohols, C₉₋₁₅ ethoxylated alcohols, alkylpolyglucosides, amine oxides and mixtures thereof.

The nonionic surfactant may be present in the composition of the invention in an amount of from 0.1 to 5 wt %, preferably 0.3 to 3.5 wt %, more preferably 0.4 to 3.2 wt %.

The cationic biocide optionally used in the present invention will be compatible with the amphoteric and nonionic surfactants. Further, the biocide optionally used in the invention must be suitably non-toxic and must be suitable for use in a kitchen environment. In particular, the biocide should be suitable for use according to The Biocidal Products Directive (BPD) 98/8/EC (HSE, UK) for use in product types 2 (Private and public health area disinfectants and other biocidal products) and 4 (Food and feed area disinfectants). Suitable examples of cationic biocides to be included in the present invention include those of the general formula

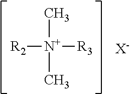

wherein R₂ and R₃ are the same or different C₈₋₁₂ alkyl, or R₂ is C₁₂-₁₆alkyl, C₈-₁₈ alkoxyphenolethoxy and R₃ is benzyl, and X is a halide, for example chloride, bromide or iodide, or is a methosulfate anion. The alkyl groups recited in R₂ and R₃ may be straight-chained or branched, but are preferably substantially linear.

Particularly useful quaternary germicides include compositions which include a single quaternary compound, as well as mixtures of two or more different quaternary compounds. Such useful quaternary compounds are available under the BARDAC®, BARQUAT®, HYAMINE®, LONZABAC® and ONYXIDE® trademarks, which are more fully described in, for example, McCutcheon's Functional Materials (Vol. 2), North American Edition, 1998.

Particularly suitable are alkyl (C12-16), dimethylbenzyl ammonium chloride (sold for example as BTC50E), octyl decyl dimethyl ammonium chloride, didecyl dimethyl ammonium chloride, dioctyl dimethyl ammonium chloride, polyhexamethylene biguanide hydrochloride (e.g. Vantocil TG) or mixtures thereof.

When a biocide is present, it is suitably present in an amount from 0.1 to 5 wt %, preferably from 0.2 to 3 wt %, more preferably from 0.5 to 2 wt %.

The composition of the invention may include a suitable alkali to adjust the final pH of the composition to a pH of from 7.0 to 12.5, preferably from 9.0 to 11.5. Suitable pH adjusters include potassium hydroxide, sodium hydroxide and ammonium hydroxide, and they are suitably included in an amount of from 0.05 to 0.2 wt % in order to adjust the pH to the desired level.

The composition of the invention includes a suitable carrier which is preferably an aqueous carrier, most preferably water, suitably deionised water. The carrier is present in an amount of from 0 to 99 wt % to make up the remainder of the composition to a total of 100 wt %, in addition to the components described above.

The compositions of the invention may further include additives such as perfumes, colour, preservative etc. In particular, lemon or other citrus perfumes or pine perfumes are particularly suitable in products of this type. Suitable colouring agents may be included to impart a desired colour to the composition.

One or more preservatives may be added to the composition to reduce the growth of microorganisms in the composition or system during extended storage. Suitable examples of preservatives include methyl parabens, ethyl parabens, glutaraldehyde, formaldehyde, 2-bromo-2-nitropropane-1,3-diol, 5-chloro-2-methyl-4-isothiazolin-3-one, 2-methyl-4-isothiazolin-3-one, 1,2-benzisothiazol-3(2H)-one, and mixtures thereof. The preservative is suitably provided in an amount of from 0.001 to 4 wt %.

The foaming microwave cleaning composition of the present invention may be prepared by mixing the ingredients, suitably at room temperature. In a typical method for preparing the composition of the invention, the following ingredients are added to water in the following order at room temperature.

Solvent

Amphoteric surfactant

Nonionic surfactant

Perfume

Cationic biocide

Preservative

pH adjustor.

The ingredients are mixed thoroughly, and if necessary any ingredient that has solidified during storage may be returned to the liquid state by heating before addition. Further mixing may then be performed to ensure homogeneity. Preferably, each ingredient is added with mixing so that complete dispersion of the ingredient is ensured before the next ingredient is added. The pH may then be adjusted with the alkaline pH adjustor.

The composition of the invention is suitably packaged in a foam- or mousse-forming pump dispenser to provide the microwave cleaning system of the invention. Such manual foam- or mousse-forming dispensers are well known in the art, for example those disclosed in EP 0613728. These dispensers generally comprise a pump assembly which can be mounted on or in an opening of a reservoir for holding the liquid to be dispensed in the form of a foam or a mousse. The pump assembly comprises a liquid pump for pumping the liquid from the reservoir and an air pump to mix air with the liquid in order to form a foam or mousse. The foam or mousse is then dispensed through a dispensing channel out of a dispensing opening. In the dispersing channel, one or more meshes or sieves may be arranged to ensure a homogenous foam. Suitable pump dispensers will have a capacity of from 50 ml to 600 ml, preferably from 100 ml to 200 ml, more preferably 150 ml.

A suitable pump dispenser is the G3 Up and Down Stroke Dispenser from Rexam.

The composition of the present invention is a foaming microwave cleaning composition. The composition may be dispensed in the form of a mousse or aerated foam from the system of the invention. In the present context, the terms mousse, foaming composition and aerated foam are interchangeable and are intended to mean a composition that remains in foam form after it is dispensed until it is mechanically compressed or is evaporated.

In use, the foaming composition is dispensed from the foam- or mousse-forming pump dispenser. Suitably, an amount of up to 200 ml, suitably from 150 to 180 ml, of the composition may be applied using the dispenser. The composition of the invention may be applied in one single pump application or in the form of a number of individual pumped amounts dispensed from the pump dispenser, each of suitably approximately 20 to 40 ml each, preferably about 30 ml each. A number of the individual amounts may be applied, say up to 10, preferably up to 8, more preferably up to 6 separate applications inside the microwave. The foaming composition may be applied to the walls, ceiling, floor or inner door surface of the microwave oven, but will preferably be applied to the floor of the microwave oven or to a removable internal plate of the oven, if present.

The door of the microwave is then closed. The microwave oven is then turned on for a short period. The water in the composition will then boil, producing a vapour phase, i.e. steam, that will have the direct effect of softening any residue. The solvent and other volatile components such as surfactants and any biocide present are carried by the vapour phase throughout the oven, reaching any residue, where they will bind to any remaining oils in the residue. The solvents and volatile components will then act on any residue inside the microwave, thus softening it. The door of the microwave oven may then be opened. However, if the residue inside the microwave oven is particularly stubborn the door of the oven may remain closed after the power has been applied for example for up to ten minutes, suitably for up to five minutes, in order to allow further penetration of the solvent and surfactants into the residue. The door of the microwave may then be opened and the surfaces may be wiped down and optionally rinsed with water using a cloth, sponge, paper towel or other suitable means in order to remove any residue. The product of the invention will preferably result in a cleaned, deodorised, and disinfected microwave.

According to the invention, from 100 to 3200 watts, preferably from 600 to 1200 watts of microwave energy are applied for a time sufficient to allow the vapour to form a foam. The time will vary with the power rating of the microwave oven, or with the level of microwave energy applied, and will generally be from 14 seconds to 7 minutes 30 seconds, preferably from 30 to 75 seconds. For generally available microwave ovens, suitable times of operation of the microwave after application of the composition of the invention and before wiping away any residue are as follows:

| Microwave Setting (watts) | Timing (s) |
|---|---|
| 500 to 600 | 75 to 90, preferably 80 |
| 600 to 650 | 65 to 75, preferably 70 |
| 700 to 750 | 55 to 65, preferably 60 |
| 800 to 850 | 45 to 55, preferably 50 |
| 900 to 1,000 | 35 to 45, preferably 40 |
| 1000 to 1,500 | 30 to 35, preferably 33 |

Generally, the microwave is used at full power, according to the settings and timings set out in the Table above. If the microwave is not used at full power, the times should be adjusted accordingly.

The following Examples are provided.

### EXAMPLES

In each of the following examples, the remaining components are added to water and mixed as necessary in order to obtain a composition that may be used in a foam- or mousse-forming pump dispenser for use in cleaning a microwave oven. All percentages referred to herein are based on the total weight of the composition.

### Examples

### Example 1

The following formulations are prepared by adding the remaining components to water and mixing as necessary in order to obtain a composition.

### Formulation 1

| Component | Wt % |
|---|---|
| DI Water | 95.0 |
| Dowanol PM | 2.0 |
| Lakeland AMA | 1.1 |
| Surfac UN65/95 | 0.5 |
| Perfume | 0.1 |
| BTC50E | 1.0 |
| Nipacide BSM | 0.2 |
| Alkali soln | 0.1 |
| | 100.0 |

### Formulation 2

| Component | Wt % |
|---|---|
| DI Water | 92.81 |
| Dowanol PM | 2.0 |
| Lakeland AMA | 1.67 |
| Surfac UN65/95 | 2.02 |
| Perfume | 0.20 |
| BTC50E | 1.0 |
| Nipacide BSM | 0.20 |
| Alkali soln | 0.10 |
| | 100.0 |

### Formulation 3

| Component | Wt % |
|---|---|
| DI Water | 84.48 |
| Ethyl Alcohol | 10.0 |
| Lakeland CAB | 2.0 |
| Surfac UN65/95 | 2.02 |
| Perfume | 0.2 |
| BTC50E | 1.00 |
| Nipacide BSM | 0.20 |
| Alkali soln | 0.10 |
| | 100.0 |

### Formulation 4

| Component | Wt % |
|---|---|
| DI Water | 85.60 |
| Isopropyl Alcohol | 8.0 |
| Lakeland AMA | 3.0 |
| Surfac UN65/95 | 2.02 |
| Perfume | 0.1 |
| BTC50E | 1.0 |
| Nipacide BSM | 0.2 |
| Alkali soln | 0.1 |
| | 100.0 |

### Formulation 5

| Component | Wt % |
|---|---|
| DI Water | 87.1 |
| Dowanol PM | 5.0 |
| Lakeland CAB | 3.34 |
| Surfac UN65/95 | 3.16 |
| Perfume | 0.10 |
| BTC50E | 1.0 |
| Nipacide BSM | 0.2 |
| Alkali soln | 0.1 |
| | 100.0 |

### Formulation 6

| Component | Wt % |
|---|---|
| DI Water | 91.9 |
| Dowanol PnB | 3.0 |
| Lakeland CAB | 2.0 |
| Surfac UN65/95 | 1.6 |
| Perfume | 0.2 |
| BTC50E | 1.0 |
| Nipacide BSM | 0.2 |
| Alkali soln | 0.1 |
| | 100.0 |

### Formulation 7

| Component | Wt % |
|---|---|
| DI Water | 95.0 |
| Dowanol PM | 2.0 |
| Lakeland AMA | 1.1 |
| Surfac UN65/95 | 0.5 |
| Perfume | 0.1 |
| BTC50E | 1.0 |
| Nipacide BSM | 0.2 |
| Alkali soln | 0.1 |
| | 100.0 |

### Formulation 8

| Component | Wt % |
|---|---|
| DI Water | 92.81 |
| Dowanol PnB | 2.0 |
| Surfac BH 30 | 1.67 |
| Mackamine CAO | 2.02 |
| Perfume | 0.20 |
| BTC50E | 1.0 |
| Nipacide BSM | 0.20 |
| Alkali soln | 0.10 |
| | 100.0 |

### Formulation 9

| Component | Wt % |
|---|---|
| DI Water | 84.48 |
| Ethyl Alcohol | 10.0 |
| Lakeland CAB | 2.0 |
| Surfac UN65/95 | 2.02 |
| Perfume | 0.2 |
| BTC50E | 1.00 |
| Nipacide BSM | 0.20 |
| Alkali soln | 0.10 |
| | 100.0 |

### Formulation 10

| Component | Wt % |
|---|---|
| DI Water | 85.60 |
| Isopropyl Alcohol | 8.0 |
| Lakeland AMA | 3.0 |
| Neodol 25-12 | 2.02 |
| Perfume | 0.1 |
| Vantocil TG | 1.0 |
| Nipacide BSM | 0.2 |
| Alkali soln | 0.1 |
| | 100.0 |

### Formulation 11

| Component | Wt % |
|---|---|
| DI Water | 87.1 |
| Dowanol PM | 5.0 |
| Lakeland CAB | 3.34 |
| Glucopon 600CS UP | 3.16 |
| Perfume | 0.10 |
| BTC50E | 1.0 |
| Nipacide BSM | 0.2 |
| Alkali soln | 0.1 |
| | 100.0 |

DI Water is de-ionised water.

### Example 2

The Formulations 1 to 11 prepared according to Example 1 are filled into a 150 ml G3 Up and Down Stroke Dispenser from Rexam.

### Example 3

Six separate quantities of Formulation 1 are dispensed from the dispenser, each of a volume of about 30 ml, onto the glass plate of a microwave oven having a full power rating of 800 watts. The power level is set to full power, and the microwave oven is turned on for 50 seconds. Once the machine turns off, the door is left closed for 2 minutes, and is then opened. The interior of the oven has a soft, sticky residue that is easily removed with a soft cloth.

1. A foaming microwave cleaning composition comprising at least one solvent having a boiling point of from 70 to 180° C., at least one high foaming amphoteric surfactant, at least one high foaming water-soluble nonionic surfactant and an aqueous carrier, the composition having a pH of from 7.0 to 12.5.

2. The microwave cleaning composition of claim 1, wherein the solvent is chosen from C 1-4 alcohols, optionally substituted with a C 1-4 alkoxy group.

3. The microwave cleaning composition of claim 2, wherein the solvent is chosen from 1-methoxy-2-propanol, ethanol, isopropanol, and 3-butoxy propan-2-ol.

4. The microwave cleaning composition of claim 1, wherein the amphoteric surfactant is chosen from β-alanine, N-(2-carboxy ethyl) Ncoco alkyl derivatives and sodium salts thereof, cocamidopropylbetaine, alkylamine dicarboxylates and mixtures thereof.

5. The microwave cleaning composition of claim 1, wherein the nonionic surfactant is chosen from polyoxyethylene C7-25 alcohols.

6. The microwave cleaning composition of claim 5, wherein the nonionic surfactant is chosen from polyoxyethylene (6) C9-11 alcohol, C9-15 ethoxylated alcohols, amine oxides and mixtures thereof.

7. The microwave cleaning composition of claim 1, wherein the composition further comprises a cationic biocide.

8. The microwave cleaning composition of claim 7, wherein the cationic biocide is chosen from alkyl (C 12-16), dimethylbenzyl ammonium chloride, octyl decyl dimethyl ammonium chloride, didecyl dimethyl ammonium chloride, dioctyl dimethyl ammonium chloride, polyhexamethylene biguanide hydrochloride and mixtures thereof.

9. A system for use in cleaning a microwave comprising a foaming microwave cleaning composition according to claim 1 filled in a foam- or mousse-forming pump dispenser.

10. A method of cleaning the interior of a microwave oven, comprising;
applying a foaming microwave cleaning composition comprising at least one solvent having a boiling point of from 70 to 180° C., at least one high foaming amphoteric surfactant, at least one high foaming water-soluble nonionic surfactant and an aqueous carrier, the composition having a pH of from 7.0 to 12.5, to the interior of the microwave oven;
applying from 100 to 3200 watts of microwave energy for a time sufficient to allow the foam to form a vapour; and
removing residue from the interior of the microwave oven.

11. A method of cleaning the interior of a microwave oven comprising;
dispensing into a microwave oven from a foam- or mousse-forming pump dispenser a foaming microwave cleaning composition comprising at least one solvent having a boiling point of from 70 to 180° C., at least one high foaming amphoteric surfactant, at least one high foaming water-soluble nonionic surfactant and an aqueous carrier, the composition having a pH of from 7.0 to 12.5; and
removing residue from the interior of the microwave oven.

12. The method according to claim 10, wherein an amount of from 600 to 1200 watts of microwave energy is applied for a time of from 30 to 75 seconds.

13. The method according to claim 11, wherein an amount of from 600 to 1200 watts of microwave energy is applied for a time of from 30 to 75 seconds.

14. The microwave cleaning composition according to claim 2, wherein the amphoteric surfactant is chosen from β-alanine, N-(2-carboxy ethyl) Ncoco alkyl derivatives and sodium salts thereof, cocamidopropylbetaine, alkylamine dicarboxylates and mixtures thereof.

15. The microwave cleaning composition according to claim 3, wherein the amphoteric surfactant is chosen from β-alanine, N-(2-carboxy ethyl) Ncoco alkyl derivatives and sodium salts thereof, cocamidopropylbetaine, alkylamine dicarboxylates and mixtures thereof.

16. The system of claim 9, wherein the solvent is chosen from C 1-4 alcohols, optionally substituted with a C 1-4 alkoxy group.

17. The system of claim 9, wherein the solvent is chosen from 1-methoxy-2-propanol, ethanol, isopropanol, and 3-butoxy propan-2-ol.

18. The system of claim 9, wherein the amphoteric surfactant is chosen from β-alanine, N-(2-carboxy ethyl) Ncoco alkyl derivatives and sodium salts thereof, cocamidopropylbetaine, alkylamine dicarboxylates and mixtures thereof.

19. The system of claim 9, wherein the nonionic surfactant is chosen from polyoxyethylene C7-25 alcohols.

20. The system of claim 9, wherein the foaming microwave cleaning composition further comprises a cationic biocide chosen from alkyl (C12-16), dimethylbenzyl ammonium chloride, octyl decyl dimethyl ammonium chloride, didecyl dimethyl ammonium chloride, dioctyl dimethyl ammonium chloride, polyhexamethylene biguanide hydrochloride and mixtures thereof.
